(19) United States
(12) Patent Application Publication
(10) Pub. No.: US 2022/0244418 A1
(43) Pub. Date: Aug. 4, 2022

(54) SYSTEM AND METHOD FOR LOCALIZED SEISMIC IMAGING AROUND WELLBORES

(71) Applicant: CHEVRON U.S.A. INC., San Ramon, CA (US)

(72) Inventor: Kevin John DAVIES, Cambridge (GB)

(73) Assignee: CHEVRON U.S.A. INC., San Ramon, CA (US)

(21) Appl. No.: 17/591,038

(22) Filed: Feb. 2, 2022

Related U.S. Application Data
(60) Provisional application No. 63/144,858, filed on Feb. 2, 2021.

(51) Int. Cl. G01V 1/50; G01V 1/22; E21B 17/20; E21B 49/00; E21B 47/002; E21B 47/005

(52) U.S. Cl. CPC G01V 1/50; G01V 1/226; E21B 17/206; E21B 49/00; E21B 47/0025; E21B 43/128; G01V 2210/74; G01V 2210/60; G01V 2210/1299; G01V 2210/1429; E21B 47/005

(57) ABSTRACT

A method is described for localized seismic imaging around a wellbore. The method uses at least one non-conventional seismic source such as an electrical submersible pump to generate seismic signals which are reflected by the surrounding wellbore and rock formation and recorded by a fiber optic cable or downhole geophones. The seismic data is then processed and imaged to generate an image of the volume around the wellbore. The method may be executed by a computer system.

### CROSS-REFERENCE TO RELATED APPLICATIONS

This application claims benefit of U.S. Provisional Application No. 63/144,858, filed Feb. 2, 2021, which is hereby incorporated by reference in its entirety.

### STATEMENT REGARDING FEDERALLY SPONSORED RESEARCH OR DEVELOPMENT

Not applicable.

### TECHNICAL FIELD

The disclosed embodiments relate generally to techniques for seismic imaging around wellbores existing in subsurface reservoirs and, in particular, to a method of localized seismic imaging around a wellbore using a non-conventional seismic source.

### BACKGROUND

Seismic exploration involves surveying subterranean geological media for hydrocarbon deposits. A survey typically involves deploying seismic sources and seismic sensors at predetermined locations on the surface or in the subsurface. The sources generate seismic waves, which propagate into the geological medium creating pressure changes and vibrations. Variations in physical properties of the geological medium give rise to changes in certain properties of the seismic waves, such as their direction of propagation and other properties.

Portions of the seismic waves reach the seismic sensors. Some seismic sensors are sensitive to pressure changes (e.g., hydrophones), others to particle motion (e.g., geophones, fiber optic cables), and industrial surveys may deploy one type of sensor or both. In response to the detected seismic waves, the sensors generate corresponding electrical or optical signals, known as traces, and record them in storage media as seismic data. Seismic data will include a plurality of “shots” (individual instances of the seismic source activating), each of which are associated with a plurality of traces recorded at the plurality of sensors.

Seismic data is often contaminated by “noise”. Noise may include any undesired seismic signals that reach the seismic sensors. For example, in marine seismic, this may include cavitation noises from host or passing ships. Although there have been examples of using ship noise as a seismic source (e.g., Davies, K., Hampson, G., Jakubowicz, H., Odegaard, J., 1992, Screw Seismic Sources. SEG Technical Program Expanded Abstracts 1992. January 1992, pages 710-711, which is incorporated by reference), it is not considered a standard source. In another example, when a well is being drilled, the drill-bit vibrations may be considered noise or may be used as a downhole seismic source (e.g., Rector J. M., 1990, Utilization of drill-bit vibrations as a downhole seismic source. A PhD dissertation submitted to the department of geophysics Stanford University available at https://pangea.stanford.edu/research/srb/docs/theses/SRB_44_SEP90_Rector.pdf, which is incorporated by reference). This drill-bit source may only be used during the drilling of the wellbore.

Seismic data is processed and imaged to create seismic images that can be interpreted to identify subsurface geologic features including hydrocarbon deposits. The ability to define the location of rock and fluid property changes in the subsurface is crucial to our ability to make the most appropriate choices for purchasing materials, operating safely, and successfully completing projects. Project cost is dependent upon accurate prediction of the position of physical boundaries within the Earth. Decisions include, but are not limited to, budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment.

There exists a need for improved localized seismic imaging around wellbores.

### SUMMARY

In accordance with some embodiments, a method of detecting seismic waves is disclosed. The method includes detecting a first plurality of seismic waves generated while a first electric submersible pump (ESP), a first logging tool, or any combination thereof is running at its operating frequency or operating frequencies within a first well. The first plurality of seismic waves is detected using at least one seismic sensor comprising a seismic sensor within the first well, a seismic sensor within a second well, a seismic sensor on a surface, or any combination thereof. The method includes recording seismic data for the first plurality of seismic waves detected by the at least one seismic sensor in an electronic storage.

In accordance with some embodiments, a system of detecting seismic waves is disclosed. The system includes a first electric submersible pump (ESP), a first logging tool, or any combination thereof within a first well. The system includes at least one seismic sensor comprising a seismic sensor within the first well, a seismic sensor within a second well, a seismic sensor on a surface, or any combination thereof to detect a first plurality of seismic waves generated while the first electric submersible pump (ESP), the first logging tool, or any combination thereof is running at its operating frequency or operating frequencies within the first well. The system includes an electronic storage to record seismic data for the first plurality of seismic waves detected by the at least one seismic sensor.

In accordance with some embodiments, a method of generating a digital seismic image is disclosed. The method includes obtaining first seismic data for a first plurality of seismic waves generated while a first electric submersible pump (ESP), a first logging tool, or any combination thereof is running at its operating frequency or operating frequencies within the first well. The first plurality of seismic waves is detected using at least one seismic sensor comprising a seismic sensor within the first well, a seismic sensor within a second well, a seismic sensor on a surface, or any combination thereof. The method includes generating a first digital seismic image of a subsurface using the first seismic data.

In accordance with some embodiments, a computer system of generating a digital seismic image is disclosed. The system includes one or more processors, memory, and one or more programs. The one or more programs are stored in the memory and configured to be executed by the one or more processors. The one or more programs include an operating system and instructions that when executed by the one or more processors cause the computer system to: obtain first seismic data for a first plurality of seismic waves generated while a first electric submersible pump (ESP), a first logging tool, or any combination thereof is running at its operating frequency or operating frequencies within the first well; and generate a first digital seismic image of a subsurface using the first seismic data. The first plurality of seismic waves is detected using at least one seismic sensor comprising a seismic sensor within the first well, a seismic sensor within a second well, a seismic sensor on a surface, or any combination thereof.

In accordance with some embodiments, a method of localized seismic imaging around a wellbore using non-conventional sources such as one or more electrical submersible pumps and a plurality of downhole seismic sensors such as a fiber optic cable is disclosed.

### BRIEF DESCRIPTION OF THE DRAWINGS

FIG. 1A is a diagram of an electrical submersible pump as a downhole seismic source, in accordance with some embodiments.

FIG. 1B is a cross-sectional view of one embodiment of the wellbore in FIG. 1A.

FIG. 1C is a cross-sectional view of one embodiment of the fiber optic cable of FIGS. 1A-1B.

FIGS. 2A-1, 2A-2, 2B-1, 2B-2, 2C-1, 2C-2, 2D-1, and 2D-2 illustrate various capillary tubing installation schemes consistent with the fiber optic cable of FIGS. 1A-1C.

FIG. 3 is a diagram of multiple electrical submersible pumps as downhole seismic sources, in accordance with some embodiments.

FIG. 4 is a flowchart that illustrates one embodiment of a method of detecting seismic waves.

FIG. 5 is a block diagram illustrating a seismic imaging system, in accordance with some embodiments.

FIG. 6 is a flowchart that illustrates one embodiment of a method of generating a digital seismic image.

Like reference numerals refer to corresponding parts throughout the drawings.

### DETAILED DESCRIPTION OF EMBODIMENTS

Described below are methods and systems of detecting seismic waves. One embodiment of a method of detecting seismic waves includes detecting a first plurality of seismic waves generated while a first electric submersible pump (ESP), a first logging tool, or any combination thereof is running at its operating frequency or operating frequencies within a first well; and recording seismic data for the first plurality of seismic waves detected by the at least one seismic sensor in an electronic storage (e.g., memory, USB, disk). The first plurality of seismic waves is detected using at least one seismic sensor comprising a seismic sensor within the first well, a seismic sensor within a second well, a seismic sensor on a surface, or any combination thereof. The detected seismic waves may be utilized to generate one or more digital seismic images, for example, for imaging of subsurface volumes adjacent to a wellbore, for localized seismic imaging around a wellbore (e.g., within one meter around the wellbore to several kilometers around the wellbore), etc.

Described below are methods, systems, and computer readable storage media that provide a manner of seismic imaging. One embodiment of a method of generating a digital seismic image includes obtaining first seismic data for a first plurality of seismic waves generated while a first electric submersible pump (ESP), a first logging tool, or any combination thereof is running at its operating frequency or operating frequencies within the first well; and generating a first digital seismic image of a subsurface using the first seismic data. The first plurality of seismic waves is detected using at least one seismic sensor comprising a seismic sensor within the first well, a seismic sensor within a second well, a seismic sensor on a surface, or any combination thereof. These embodiments are designed to be of particular use for seismic imaging of subsurface volumes adjacent to a wellbore. For example, the principles of the present invention includes embodiments of a method and system for localized seismic imaging around a wellbore.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

Non-Conventional Seismic Source: Electrical Submersible Pumps (ESP's) are commonly deployed down hole in the oil and gas industry to manage fluid and gas flow. ESP's emit acoustic energy typically classed as “noise”. For example, the noise may be from electrical hum, bearing rumble, cavitation, fluid and gas flow, or any combination thereof (e.g., (i) Davies, K., Hampson, G., Jakubowicz, H., Odegaard, J., 1992, Screw Seismic Sources. SEG Technical Program Expanded Abstracts 1992. January 1992, pages 710-711, (ii) CA2087908, and (iii) EP0553053, each of which is incorporated by reference). This invention disclosure concerns use of noise from non-conventional seismic sources such as ESPs as the seismic source energy (signal) in conjunction with downhole seismic receivers (also referred to as seismic sensors) for imaging in and around the wellbore. Although ESPs are described as the seismic source in an embodiment, this is not meant to be limiting; any non-conventional seismic source that generates seismic energy i.e., acoustic or elastic waves, e.g., fluid cavitating, bubble pulses, mechanical devices, resulting tube waves, earthquakes, passive seismicity, migration of particles (e.g., sand ingress), or any combination thereof is within the scope of this method. Indeed, another example of a non-conventional seismic source is a logging tool, such as in wireline logging.

Electrical hum, bearing rumble, cavitation, fluid and gas flow, or any combination thereof may all generate more than a single fundamental frequency. Turning to cavitation, ESP suction side, pressure side, and/or tip vortex cavitation are naturally broad band and can include frequencies that otherwise require manipulation to generate (e.g., (i) Davies, K., Hampson, G., Jakubowicz, H., Odegaard, J., 1992, Screw Seismic Sources. SEG Technical Program Expanded Abstracts 1992. January 1992, pages 710-711, which is incorporated by reference). Electrical hum and bearing rumble are also not necessarily mono-frequencies emitters, as in addition to fundamental frequency, this system naturally generates harmonics. Furthermore, non-linear superposition from multiple natural frequency emitters enables more frequencies than the parts resulting in further broadening of the spectrum, for example, from multiple ESPs running together. Fluid and gas flow is broad band, but potentially low power noise. The noise from fluid and gas flow may be utilized as a non-conventional source by measuring over long periods to overcome low power.

As will be described further herein, a plurality of seismic waves is generated while one or more non-conventional seismic sources (e.g., one or more ESPs, one or more logging tools, or any combination thereof) is running at its operating frequency or operating frequencies within a well. The operating frequencies may be higher than 0 Hertz to about 900 Hertz for the non-conventional source(s). Some embodiments consistent with the present disclosure intend to make use of ESP(s) already in place in a well and/or deployed for independent primary use (i.e., fluid production control). There is no requirement to interfere with the primary use or equipment, whether during ESP installation or during ESP operation. Similarly, some embodiments consistent with the present disclosure intend to make use of logging tool(s) already in place in a well and/or deployed for independent primary use (i.e., logging). There is no requirement to interfere with the primary use or equipment, whether during logging tool installation or during logging tool operation. Examples of logging tools include, but are not limited to, logging while drilling (LWD) tools, measure while drilling (MWD) tools, nuclear magnetic resonance (NMR) logging tools, wireline tools, etc.

Seismic Sensor: A “seismic sensor” or “seismic receiver” refers to practically anything that detects seismic waves. In some embodiments, at least one seismic sensor comprises fiber optic distributed sensing, such as, but not limited to, a fiber optic cable configured for distributed acoustic sensing (DAS). In some embodiments, at least one seismic sensor comprises one or more fiber optic cables configured for DAS (also referred to as DAS fiber optic cable). In some embodiments, at least one seismic sensor comprises one or more geophones, one or more accelerometers, one or more point sensors, or any combination thereof. A single well may include a single seismic sensor or a plurality of seismic sensors, for example, a single well may include a single fiber optic cable configured for DAS or a plurality of fiber optic cables configured for DAS (e.g., a helical wound fiber optic cable configured for DAS and another fiber optic cable that is not helically wound configured for DAS).

Of note, there is no requirement to connect the “seismic sensor” (e.g., fiber optic cable configured for DAS) to the “non-conventional source” (e.g., ESP, logging tool). For example, a fiber optic cable configured for DAS that is already deployed in the same well as an ESP may be utilized, and the fiber optic cable is not connected to the ESP. Moreover, a seismic sensor may even be deployed in an adjacent well or adjacent wells to the well with the ESP in this example. In some embodiments, the seismic sensor, such as the fiber optic cable configured for DAS, has no electrical connectivity requirements and it is purely optical.

Of note, it should be understood that the fiber optic cable discussed herein is configured for DAS, even if the terminology “configured for DAS” is not utilized each time. For example, the fiber optic cable configured for DAS detects a plurality of seismic waves that is generated while an ESP, a logging tool, or any combination thereof is running at its operating frequency or operating frequencies within a well. The fiber optic cable may detect during ESP ramp up or ESP ramp down. In some embodiments, the fiber optic cable may also be configured to perform distributed temperature sensing (DTS). In some embodiments, the fiber optic cable may also be configured to perform distributed pressure sensing (DPS). In some embodiments, the fiber optic cable may also be configured to perform distributed strain sensing (DSS). Indeed, the fiber optic cable may perform DPS, DTS, DSS, or any combination thereof, as well DAS, depending on the embodiment.

A previously installed fiber optic cable may already be configured for DAS (and optionally DPS and/or optionally DTS and/or optionally DSS), and this previously installed fiber optic cable may be utilized herein. Alternatively, a new fiber optic cable configured for DAS (and optionally DPS and/or optionally DTS and/or optionally DSS) may be installed. The techniques and equipment to be used to install the fiber optic cable may depend on whether the fiber optic cable is to be installed in a permanent, pumpable, or temporary manner, as well as the location where the fiber optic cable is to be installed. For example, the equipment may include clamps, straps, reels, within cement, etc., but for simplicity, the items related to installing the fiber optic cable will just be referred herein as “fiber optic installation apparatus.”

The fiber optic cable may include one or more scatterers. The fiber optic cable may include one or more diffractors. The fiber optic cable may include one or more reflectors. The fiber optic cable includes one or more optical fibers used for DAS. In one embodiment, an unmodified, substantially continuous length of standard optical fiber may be used, requiring little or no modification or preparation for use as a DAS optical fiber. The fiber optic cable configured for DAS may optionally include one or more optical fibers for DPS and/or may optionally include one or more optical fibers for DTS, and/or may optionally include one or more optical fibers for DSS. Thus, the fiber optic cable includes at least one optical fiber that may be, but is not limited to: one or more optical fibers used for DAS, one or more optical fibers for DPS, one or more optical fibers used for DTS, one or more optical fibers used for DSS, or any combination thereof. The optical fibers may include multimode optical fibers, single mode optical fibers, etc.

Each DAS optical fiber of the fiber optic cable may be optically interrogated by one or more input pulses to provide substantially continuous sensing of strain or vibrational activity along its length. An interrogator (e.g., at the surface) may be connected to the DAS optical fiber for the interrogation. The DAS optical fiber may be either single-mode or multimode. Optical pulses are launched into the DAS optical fiber and the radiation backscattered from within the DAS optical fiber is detected and analyzed. Backscattering (e.g., Rayleigh backscattering) analysis is used to quantify vibration, seismic waves, sound, strain, etc. By analyzing the radiation backscattered within the DAS optical fiber, the DAS optical fiber can effectively be divided into a plurality of sensing portions or points which may be (but do not have to be) contiguous. Mechanical vibrations of the DAS optical fiber, for instance from the non-conventional seismic sources, cause a variation in the amount of backscatter (e.g., Rayleigh backscatter) from that portion. This variation can be detected and analyzed and used to give a measure of the acoustic spectrum intensity of disturbance of the DAS optical fiber at that portion. In some embodiments, the term “acoustic” may be taken to mean any type of mechanical vibration or pressure wave, including seismic waves and sounds from sub-Hertz to 20 KHz. Besides the intensity (amplitude) and distance, other factors that can be measured include frequency, phase, duration, and signal evolution of the transients.

In short, the fiber optic cable may be coupled to an interrogator. The interrogator may be on the surface (e.g., land surface, on a sea surface vessel), or the interrogator may even be a “marinized interrogator” such as on the seafloor. The interrogator contains opto-electronic components. The interrogator provides light (e.g., laser light) into the fiber optic cable and receives the backscatter energy from the fiber optic cable. For example, one or more non-conventional seismic sources causes strain, and the strain causes the backscatter energy from the fiber optic cable. The interrogator converts the backscatter energy into arrival times and generates DAS data that includes the arrival times. The DAS data may be sent from the interrogator to at least one computer system for processing. The DAS data may be stored in electronic storage in the interrogator, in at the least one computer system, etc. In some embodiments, the DAS data (before processing, during processing, or after processing) may be combined with other data (e.g., ground truth data, core data, etc.). Thus, the seismic signal detected by the fiber optic cable is recorded in electronic storage at the interrogator as a seismic dataset and then the recorded seismic data may be sent from the interrogator to a computer system for processing at the computer system.

Fiber Optic Cable/Core: Turning to a more detailed discussion about the structure of the fiber optic cable, the fiber optic cable includes at least one optical fiber that may be surrounded by at least one protective layer to shield the at least one optical fiber against the environment. One embodiment of the fiber optic cable comprises a capillary tubing (also referred to as capillary tube) to house the at least one optical fiber. The capillary tubing may be filled with a fluid, e.g., a hydrogen scavenging gel, an inert heat transfer fluid, or an inert gas. In one embodiment, the filling fluid is a gel designed to scavenge hydrogen and protect the at least one optical fiber from hydrogen darkening. The gel also helps to support the weight of the at least one optical fiber within the capillary tubing. In another embodiment, the capillary tubing is filled with an inert gas such as nitrogen to avoid exposure of the at least one optical fiber to water or hydrogen, thereby minimizing any hydrogen-induced darkening of the at least one optical fiber during oilfield operations. In one embodiment, a single capillary tubing is used, which contains a plurality of optical fibers. In another embodiment, multiple capillary tubings may be used, with each capillary tubing containing one or more optical fibers.

A variety of installation options may be utilized: permanent, pumpable, or temporary. With the pumpable option, two capillary tubings are used to enable pumping fluid to be pumped down the capillary tubing and returned to the surface. A turnaround sub with a U-tube geometry is used at the deepest wellbore placement to join the two capillary tubings and enable pumping. The viscous drag force of the pumped fluid on the at least one optical fiber enables recovery and replacement. The pumping of the at least one optical fiber may occur in a factory, controlled surface environment, or at the wellsite with the at least one optical fiber in the wellbore. The pumpable option may be used if one or two optical fibers are used. The pumpable option allows the at least one optical fiber to be recovered and replaced should it experience hydrogen darkening.

With the permanent option, at least one optical fiber is installed inside a capillary tubing in a factory or controlled environment. If a permanently installed optical fiber becomes damaged due to hydrogen darkening or thermal degradation, the recourse is a complete replacement. The permanent and pumpable options may strap or clamp the capillary tubing to the outside of casing, liners, and tubing, or installed inside a coiled tubing instrument tube.

With the temporary option, at least one optical fiber is run into a wellbore off a reeling system into the tubing or into a coiled tubing instrument tube. The coiled tubing instrument tube could be free hanging in the tubing-casing annulus or strapped to the tubing, casing, or liner. The temporary deployable optical fiber may use a small diameter FIMT (fiber in metal tube) with an outside diameter of 0.09 to 0.15 inches, which is reinforced with fiber glass, polyproylene, polyethylene, carbon fiber, or any combinations of the foregoing which encases and protects the FIMT. This temporary option is designed to be run in and out of many wellbores and installed for a few hours to a few weeks to acquire data.

Some installation options may depend on whether a wellbore is existing or new. In one embodiment, for an existing wellbore, installation may be inside the liner or casing on the tubing or coiled tubing to take advantage of the preexisting structure. However, for a newly drilled wellbore, installation may be either inside or outside the liner or casing with trade-offs between cost, risk, etc.

In short, those of ordinary skill in the art will appreciate that various installation options are available. In one embodiment, the capillary tubing may be attached to the outer surface of the tubing with a plurality of clamps, or any known method for coupling conduits. Further, in some embodiments, it should be appreciated that the capillary tubing need not be coupled to the tubing, but it may be coupled to any other conduits in the wellbore or the casing/liner itself, or it may be integral with the casing/liner, e.g., the capillary tubing may be positioned in the annulus, clamped/strapped/fastened to any of the tubing, inside the tubing, the liner, the casing, the instrument coiled tubing, or any combination thereof. Thus, the installation scheme that is chosen may depend upon whether the wellbore is new or preexisting, components of the wellbore, etc.

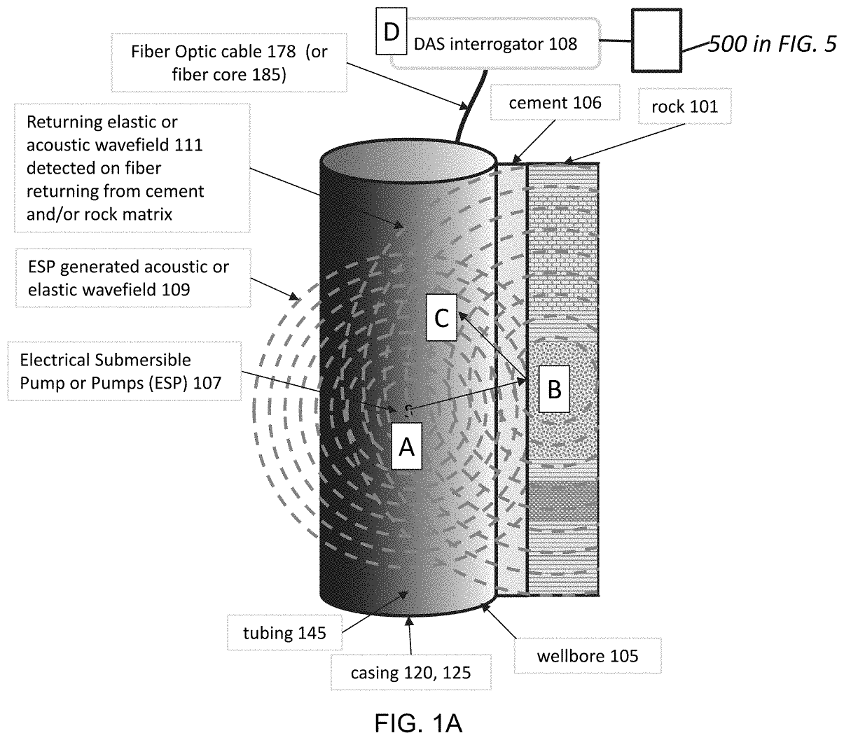

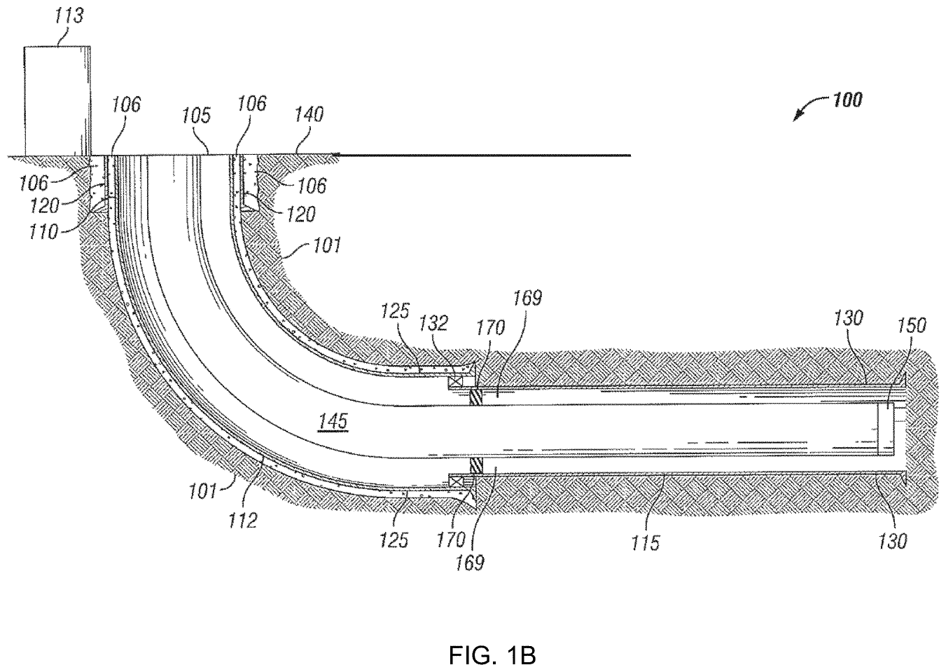

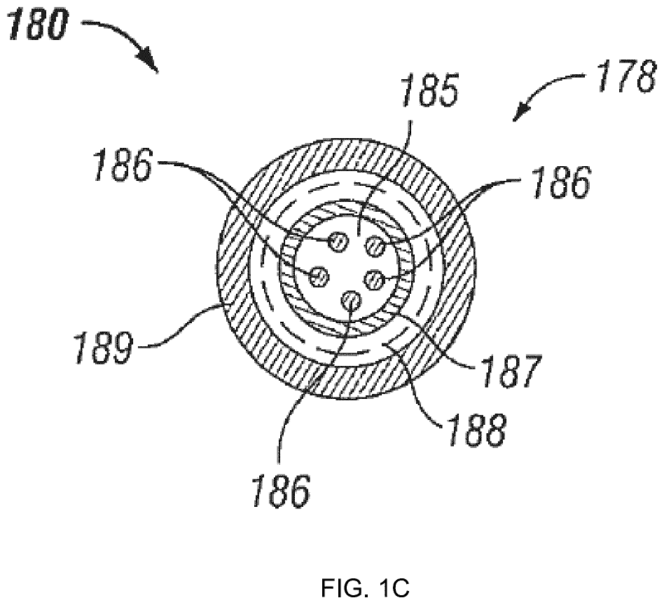

Wellbore: Turning to FIGS. 1A-1C, FIG. 1A is a diagram of an electrical submersible pump as a downhole seismic source, in accordance with some embodiments. A portion of a wellbore 105 having an ESP 107 is illustrated. The wellbore 105 may contain the tubing 145 and will contain the casing (e.g., a surface casing 120 and/or a production casing 125 referred to as casing 120, 125) with cement 106 between the casing 120, 125 and surrounding rock 101 (also referred to as subsurface). Inside the tubing 145 is the ESP 107. Coupled to the tubing 145 is a fiber optic cable 178 (or fiber core 185). The fiber optic cable 178 (or fiber core 185) may be outside the casing (cemented between casing 120, 125 and rock 101), lose inside the casing 120, 125, clamped to the outside of the tubing 145, loose inside the tubing 145, or even built into the casing or tubing material. The fiber optic cable 178 (or fiber core 185) is connected to the distributed acoustic sensing (DAS) interrogator 108.

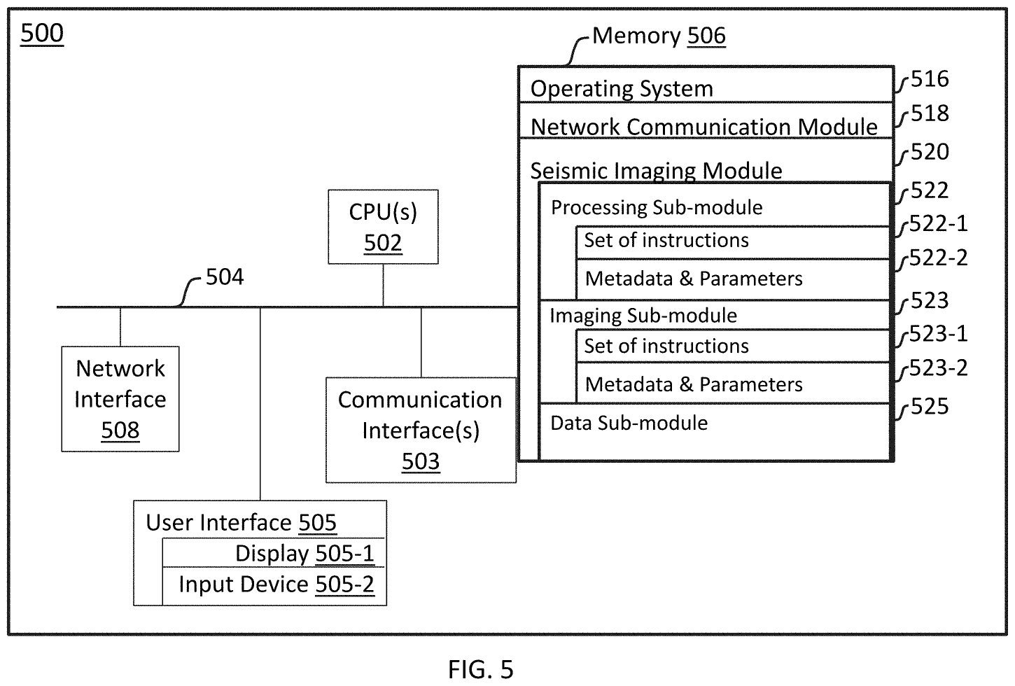

At step A, the ESP 107 generates an acoustic or elastic wavefield 109 while the ESP 107 is running at its operating frequency or operating frequencies. At step B, the acoustic or elastic wavefield 109 refracts or reflects at interfaces in the cement 106 and/or rock 101. At step C, the returning acoustic or elastic wavefield 111 is detected on the fiber optic cable 178 (or fiber core 185). At step D, the seismic signal detected by the fiber optic cable 178 (or fiber core 185) is recorded at the DAS interrogator 108 as a seismic dataset. The seismic signal detected by the fiber optic cable 178 (or fiber core 185) may be recorded in an electronic storage at the DAS interrogator 108 as the seismic dataset and then the recorded seismic data may be sent from the DAS interrogator 108 to a computer system 500 (FIG. 5) for processing at the computer system 500. Although this figure shows the seismic signal being recorded by the fiber optic system, the seismic signal may also be recorded by downhole electrical sensors such as accelerometers or geophones. One or more fiber optic cables, one or more accelerometers, one or more geophones, one or more point sensors, and/or other seismic sensors may be deployed and utilized in the wellbore 105 in some embodiments.

FIG. 1B is a cross-sectional view of one embodiment of the wellbore in FIG. 1A, with FIG. 1A illustrating a vertical trajectory and FIG. 1B illustrating a horizontal trajectory. The wellbore 105 is a horizontal wellbore in FIG. 1B and it includes a vertical section 110, the build section 112, and a horizontal section 115. The area between the vertical section 110 and the horizontal section 115 is referred to as the heel and the area towards the end of the horizontal section 115 is referred to as the toe. For example, unconventional reservoirs may be produced using horizontal wellbores, such as the wellbore 105.

The wellbore 105 may be drilled with at least one drilling apparatus 113 through a surface 140 (e.g., terrestrial surface, seafloor, etc.) and into the rock 101 (e.g., subsurface). The drilling apparatus 113 may include a drill bit, a drill string, etc. The wellbore 105 may be cemented as illustrated by cement 106. The wellbore 105 may include a surface casing 120 along a portion of the wellbore 105, a production casing 125 along a portion of the wellbore 105, and a liner 130 (e.g., a slotted liner) attached by at least one liner hanger 132. The wellbore 105 may also include a tubing 145 within the surface casing 120, the production casing 125, and the liner 130. The tubing 145 may be of standard sizes known in the industry (e.g., outermost diameter of 2⅜ inches to 4.5 inches) for standard and commonly known casing sizes (e.g., outermost diameter of 4½ inches to 12 inches), each of which have lengths in the tens to hundreds of feet. The tubing 145 includes a plurality of tubulars tubing joints, pup joints, packers (e.g., may include centralizers), etc. The end of the tubing 145 (e.g., at the toe) includes a bull plug 150. At least one packer 170 may be located in an annulus 169 between the tubing 145 and the liner 130.

In operation, the wellbore 105 may be utilized for hydrocarbon production, including waterflooding, etc. For example, water may enter the tubing 145, and the water is injected into the adjacent rock 101 through flow control devices, perforations, etc. The hydrocarbons from the rock 101 flow into the wellbore 105 and up towards the surface 140 for refining, transporting, etc.

Those of ordinary skill in the art will appreciate that various modifications may be made to the wellbore 105. For example, the wellbore 105 may simply be a vertical wellbore, instead of a horizontal wellbore, in a different embodiment. Examples of vertical wellbores are provided in FIG. 1A as well as U.S. Patent Application Publication No. 2014/0288909 (Attorney Dkt. No. T-9407) and U.S. Patent Application Publication No. 2017/0058186 (Attorney Dkt. No. T-10197), each of which is incorporated by reference in its entirety. Furthermore, a plurality of wellbores, instead of the single wellbore 105 illustrated in FIG. 1B, may be drilled through the surface 140 and into the rock 101.

Fiber Optic Cable—Capillary Tubing: One embodiment of the fiber optic cable 178 comprises a capillary tubing 180. FIG. 1C illustrates an expanded view, in cross-section, of the capillary tubing 180. The capillary tubing 180 is one embodiment of the fiber optic cable 178, however, those of ordinary skill in the art will appreciate that there are other designs and the appended claims are not limited to any disclosed embodiments. The capillary tubing 180 may have a length of tens of feet to hundreds of feet. For example, the capillary tubing 180 may be practically the entire length of the wellbore 105, or optionally, a portion of the entire length of the wellbore 105. The outer diameter of the capillary tubing 180 may be about ⅛ inches to about ⅜ inches. The outer diameter of the capillary tubing 180 may be about ¼ inches. The dimensions of the capillary tubing 180 may vary as long as the wavefield is detected to record seismic data.

Starting from the inside, the capillary tubing 180 includes the core 185 comprised of a first protective layer that is typically of an Inconel® or Incoloy® alloy 25, a stainless steel, or any combination thereof with at least one optical fiber 186 with at least one sensing portion inside the core 185. One or more of the optical fibers 186 is a DAS optical fiber, but other sensing capabilities, such as DPS and/or DTS, may be available in some embodiments. The optical fibers 186 may have high temperature coatings and coating combinations, including polyimide, high temperature acrylates, silicone-PFA, hermetic carbon, or any combination thereof to prevent hydrogen darkening. The core 185 may be filled with fluid, and the fluid surrounds each optical fiber 186. The fluid may be a gel or inert gas as discussed hereinabove. The inner diameter of the core 185 may be about 0.05 inches to about 0.10 inches. The combination of the first protective layer and the optical fiber(s) is commonly referred to as a FIMT or fiber in metal tube. The length of the core 185 depends on the length of the capillary tubing 180.

Adjacent to the core 185 may be an optional second protective layer 187, which may be of a metallic material such as aluminum. The diameter of the second protective layer 187 is optional, but may be about 0.10 inches to about 0.20 inches. The length of the second protective layer 187 depends on the length of the capillary tubing 180.

Adjacent to the optional second protective layer 187 may be a third protective layer 188, which may be of a metallic material (e.g., Inconel® or Incoloy® alloy 25, a stainless steel, or any combination thereof). The diameter of the third protective layer 188 may be about 0.20 inches to about 0.40 inches. The length of the third protective layer 188 depends on the length of the capillary tubing 180.

Adjacent to the third protective layer 188 may be an encapsulation protective layer 189, which is an extruded encapsulation polymer (e.g., polyethylene, polypropolyene, Teflon™ brand, Hypalon™ brand, or any combination thereof). The diameter of the encapsulation protective layer 189 may be about 0.25 inches to about 0.75 inches. The length of the encapsulation protective layer 189 depends on the length of the capillary tubing 180.

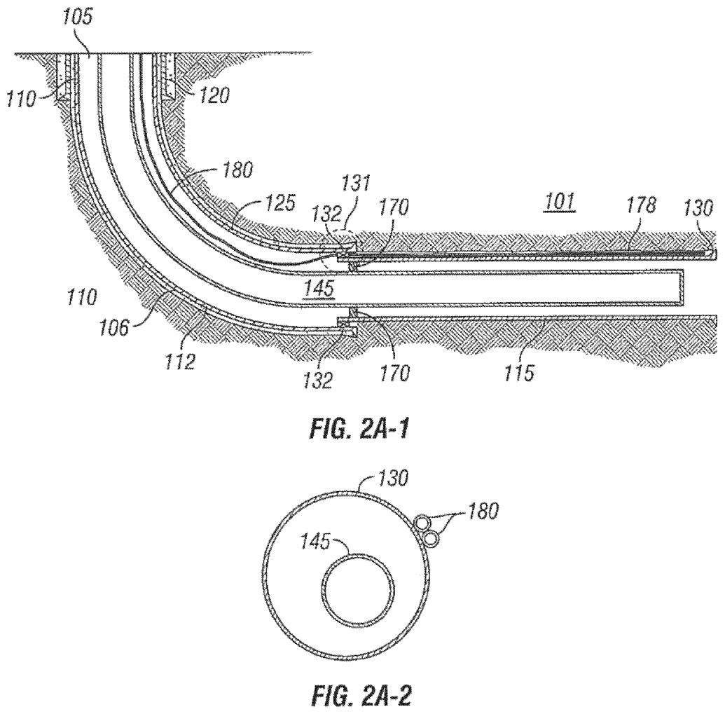

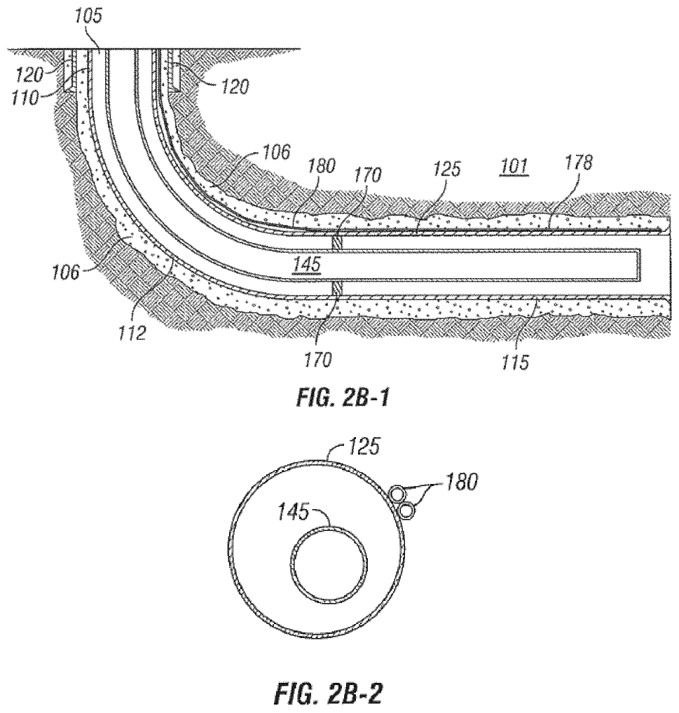

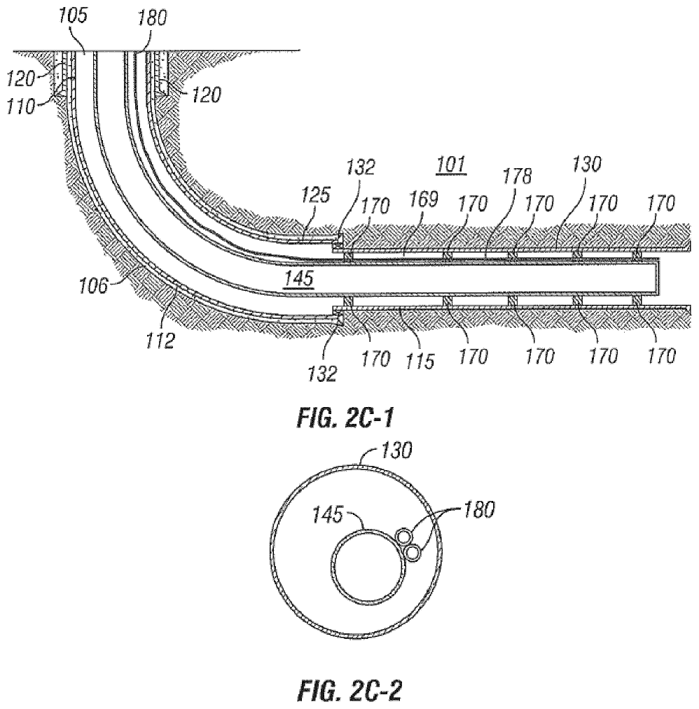

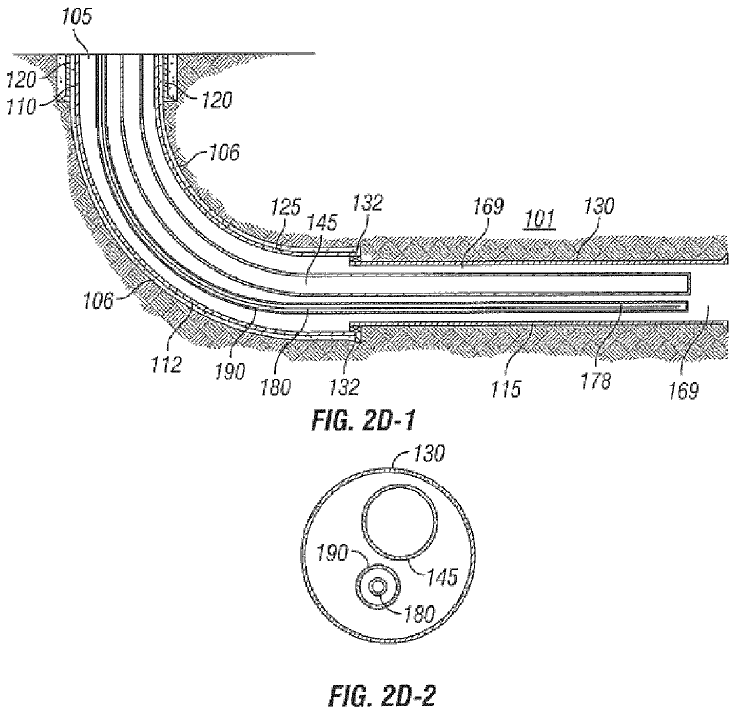

Fiber Optic Cable—Capillary Tubing Clamped to Liner: FIGS. 2A-1 and 2A-2 illustrate an embodiment with a hydraulic wet connect at liner top 131 with the capillary tubing 180 being clamped to the tubing 145 above the liner top 131. There may be one or more of the capillary tubing 180. In the embodiment of FIGS. 2A-1 and 2A-2, the capillary tubing 180 may be installed outside of the liner 130 in the horizontal section 115 of the wellbore 105, and clamped on the tubing 145 in the vertical section 110. The capillary tubing 180 includes the core 185 and at least one optical fiber 186 is inside the core 185. One or more of the optical fibers 186 is a DAS optical fiber. The optical fiber 186 of FIG. 1C (e.g., the DAS fiber, etc.) may be permanently installed in the capillary tubing 180 or can be pumped and retrieved through pumping to/from the capillary tubing 180. The hydraulic wet connect is used to connect the optical fiber 186 in the horizontal section 115 and the vertical clamped section 110. The tubing 145 can be run in and out of the wellbore without damaging the optical fiber 186 in the horizontal section 115. This setup may include at least one packer 170.

Fiber Optic Cable—Capillary Tubing Clamped to Casing: FIGS. 2B-1 and 2B-2 illustrate an embodiment in which the capillary tubing 180 may be clamped to the casing, such as the production casing 125. There may be one or more of the capillary tubing 180. The installation scheme of FIGS. 2B-1 and 2B-2 is similar to the liner deployed surveillance scheme of FIGS. 2A-1 and 2A-2. As illustrated, the complete system is installed outside of the casing 125. The capillary tubing 180 is clamped to the casing 125 as the casing 125 is installed into the wellbore 105. The capillary tubing 180 includes the core 185 and at least one optical fiber 186 is inside the core 185. One or more of the optical fibers 186 is a DAS optical fiber. The optical fiber 186 may be retrieved and replaced when designed with the pumpable option. In another embodiment, a single capillary tubing 180 may be run with single or multiple permanent optical fibers 186. The perforations may be shot 180 degrees away from the capillary tubing 180. The capillary tubing 180 may be run with ½ inch steel cables on either side of the ¼ inch capillary tubing 180 to facilitate electro-magnetic orienting of perforating guns. This setup may include at least one packer 170.

Fiber Optic Cable—Capillary Tubing Clamped to Tubing: FIGS. 2C-1 and 2C-2 illustrate an embodiment in which the capillary tubing 180 may be clamped to the tubing 145. There may be one or more of the capillary tubing 180. In one embodiment of this scheme, the capillary tubing 180 is only clamped on the tubing 145 and no other component. In another embodiment, the capillary tubing 180 may be installed inside the tubing 145. The capillary tubing 180 includes the core 185 and at least one optical fiber 186 is inside the core 185. One or more of the optical fibers 186 is a DAS optical fiber. The installation scheme in this setup is flexible, which facilitates the changes in the optical fiber 186 design and specifications. Additionally, the optical fiber 186 and capillary tubing 180 are retrievable. This setup may include at least one packer 170, and the capillary tubing 180 may penetrate through each packer 170.

Fiber Optic Cable—Capillary Tubing inside Instrument Coiled Tubing: FIGS. 2D-1 and 2D-2 illustrate an embodiment in which the capillary tubing 180 may be positioned within an instrument coiled tubing 190. There may be one or more of the capillary tubing 180. In one embodiment, the scheme of FIGS. 2D-1 and 2D-2 is used as a temporary surveillance method (e.g., for a few days) so there is less chance of fiber degradation and capillary tubing corrosion. In another embodiment, the scheme works best with a larger size of liner 130 or casing 125 to avoid damage to the optical fiber 186 and sticking in the wellbore 105. The capillary tubing 180 includes the core 185 and at least one optical fiber 186 is inside the core 185. One or more of the optical fibers 186 is a DAS optical fiber. The scheme of FIGS. 2D-1 and 2D-2 is flexible, allowing retrieval of optical fiber 186/capillary tubing 180. This setup may not include any packers 170.

FIGS. 1A, 1B, 1C, 2A-1, 2A-2, 2B-1, 2B-2, 2C-1, 2C-2, 2D-1, and 2D-2 are not necessarily drawn to scale and those of ordinary skill will appreciate that various modifications may be made. Those of ordinary skill in the art will appreciate that the embodiments of the fiber optic cable provided herein are non-limiting, and for example, a fiber optic cable may include at least one core (e.g., single core, multicore), at least one optical fiber (e.g., a DAS optical fiber), other components, etc. As another example, dimensions, materials, components, connectors, etc. may vary and may be based, for example, on compatibility with the conditions on and under the surface 140. Fiber optics are also discussed in U.S. Pat. No. 10,344,585 (Attorney Dkt. No. T-10077), U.S. Pat. No. 10,233,744 (Attorney Dkt. No. T-10089), and U.S. Pat. No. 10,233,745 (Attorney Dkt. No. T-10242), each of which is incorporated by reference. A discussion of fiber optics in a marine environment is provided in U.S. Patent App. Pub. No. 2018/0100939 (Attorney Dkt. No. T-10466) and U.S. Pat. No. 11,079,508 (Attorney Dkt. No. T-10608), which is incorporated by reference in its entirety. An additional discussion of fiber optics is provided in U.S. Patent App. Pub. No. 2018/0031734 (Attorney Dkt. No. T-10258), U.S. Patent App. Pub. No. 2019/0339408 (Attorney Dkt. No. T-10792), and U.S. Pat. No. 10,901,103 (T-10476), each of which is incorporated by reference in its entirety.

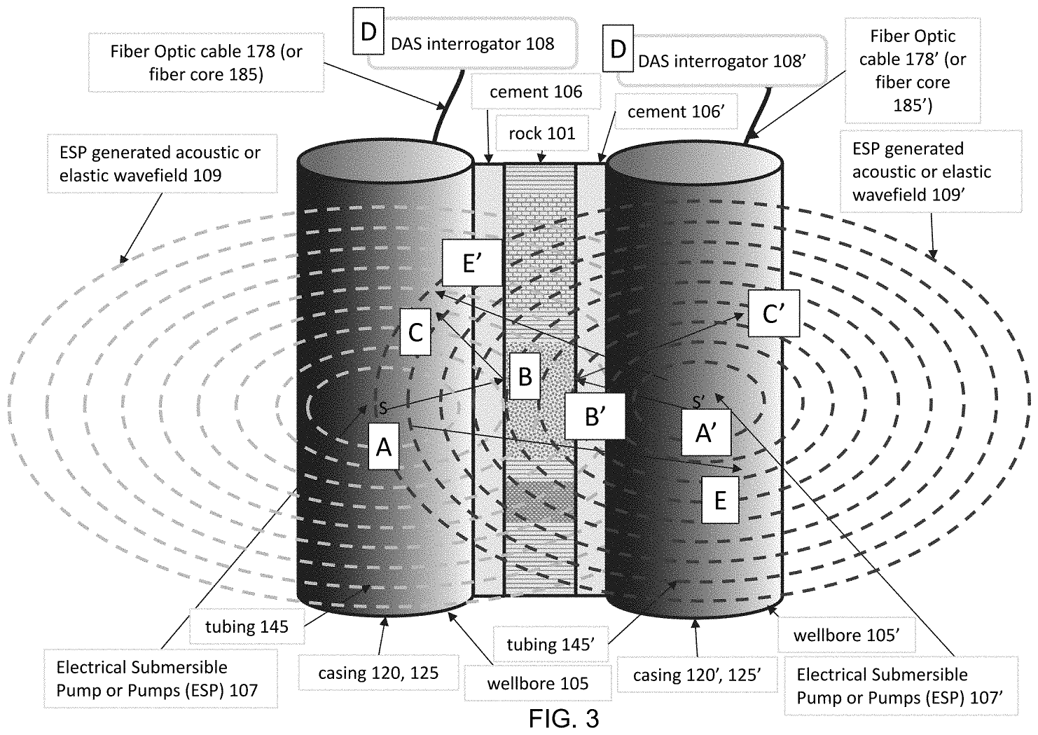

Turning to FIG. 3, this figure is a diagram of multiple electrical submersible pumps as downhole seismic sources, in accordance with some embodiments. FIG. 3 is similar to FIG. 1A with the addition of a second ESP. The differences are illustrated with an apostrophe. FIG. 3 illustrates a portion of a wellbore 105′ having an ESP 107′. The wellbore 105′ may contain the tubing 145′ and will contain the casing (e.g., a surface casing 120′ and/or a production casing 125′ referred to as casing 120′, 125′) with cement 106′ between the casing 120′, 125′ and surrounding rock 101 (also referred to as subsurface). Inside the tubing 145′ is the ESP 107′. Coupled to the tubing 145′ is a fiber optic cable 178′ (or fiber core 185′). The fiber optic cable 178′ (or fiber core 185′) may be outside the casing (cemented between casing 120′, 125′ and rock 101), lose inside the casing 120′, 125′, clamped to the outside of the tubing 145′, loose inside the tubing 145′, or even built into the casing or tubing material. The fiber optic cable 178′ (or fiber core 185′) is connected to the distributed acoustic sensing (DAS) interrogator 108′.

At step A′, the ESP 107′ generates an acoustic or elastic wavefield 109′ while the ESP 107′ is running at its operating frequency or operating frequencies. At step B′, the acoustic or elastic wavefield 109′ refracts or reflects at interfaces in the cement 106′ and/or rock 101. At step C′, the returning acoustic or elastic wavefield (not shown) is detected on the fiber optic cable 178′ (or fiber core 185′). At step E, the acoustic or elastic wavefield 109 from ESP 107 is detected on the fiber optic cable 178′ (or fiber core 185′). At step D′, the seismic signal detected by the fiber optic cable 178′ (or fiber core 185′) is recorded at the DAS interrogator 108′ as a seismic dataset. The seismic signal detected by the fiber optic cable 178′ (or fiber core 185′) may be recorded in an electronic storage at the DAS interrogator 108′ as the seismic dataset and then the recorded seismic data may be sent from the DAS interrogator 108′ to the computer system 500 (FIG. 5) for processing at the computer system 500.

At step A, the ESP 107 generates an acoustic or elastic wavefield 109 while the ESP 107 is running at its operating frequency or operating frequencies. At step B, the acoustic or elastic wavefield 109 refracts or reflects at interfaces in the cement 106 and/or rock 101. At step C′, the returning acoustic or elastic wavefield (not shown) is detected on the fiber optic cable 178 (or fiber core 185). Furthermore, at step E′, the acoustic or elastic wavefield 109′ from ESP 107′ is detected on the fiber optic cable 178 (or fiber core 185). At step D, the seismic signal detected by the fiber optic cable 178 (or fiber core 185) is recorded at the DAS interrogator 108 as a seismic dataset. The seismic signal detected by the fiber optic cable 178 (or fiber core 185) may be recorded in an electronic storage at the DAS interrogator 108 as the seismic dataset and then the recorded seismic data may be sent from the DAS interrogator 108 to the computer system 500 (FIG. 5) for processing at the computer system 500.

Although this figure shows the seismic signal being recorded by the fiber optic system, the seismic signal may also be recorded by downhole electrical sensors such as accelerometers or geophones. Those of ordinary skill in the art will appreciate that various modification/variations are within the principles of the present invention. Indeed, one or more seismic sensors such as one or more fiber optic cables, one or more accelerometers, one or more geophones, one or more point sensors, and/or other seismic sensors may be utilized in the wellbore 105 in some embodiments. One or more seismic sensors such as one or more fiber optic cables, one or more accelerometers, one or more geophones, one or more point sensors, and/or other seismic sensors may be utilized in the wellbore 105′ in some embodiments. One or more seismic sensors such as one or more fiber optic cables, one or more accelerometers, one or more geophones, one or more point sensors, and/or other seismic sensors may be utilized in each wellbore 105 and wellbore 105′ in some embodiments. One or more non-conventional seismic sources such as one or more ESPs, one or more logging tool, and/or other non-conventional seismic sources may be utilized in the wellbore 105 in some embodiments. One or more non-conventional seismic sources such as one or more ESPs, one or more logging tool, and/or other non-conventional seismic sources may be utilized in the wellbore 105′ in some embodiments. One or more non-conventional seismic sources such as one or more ESPs, one or more logging tool, and/or other non-conventional seismic sources may be utilized in each wellbore 105 and wellbore 105′ in some embodiments. Furthermore, mixing of non-conventional seismic sources in a single well is contemplated. As an example, this disclosure contemplates running at least one tool down the inside of a tubing while one or more ESPs are at least in place, if not running. Similarly, mixing of seismic sensors in a single well is also contemplated.

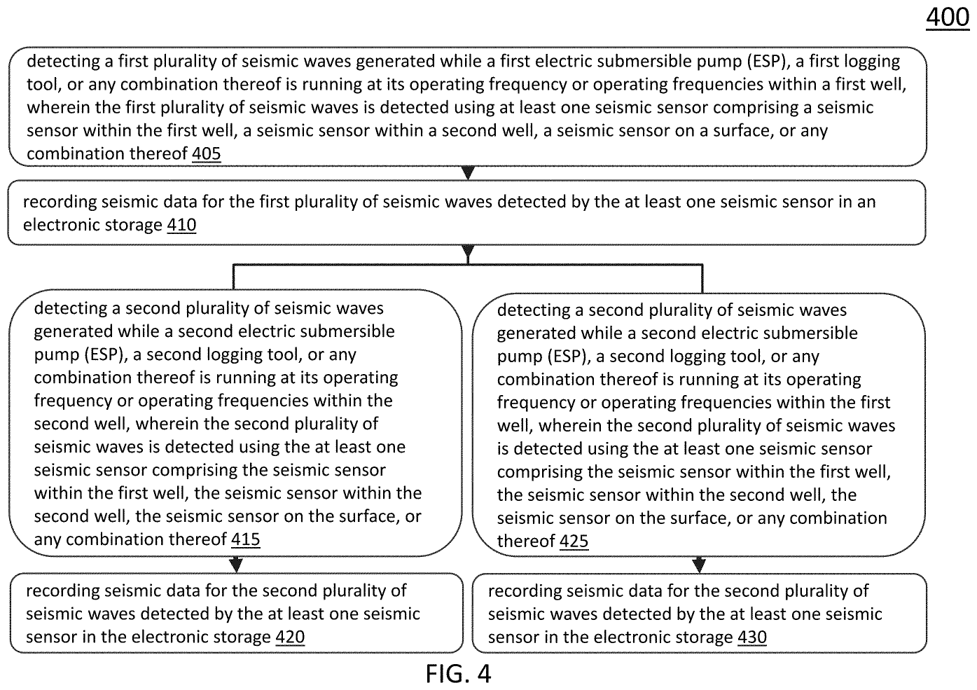

FIG. 4 is a flowchart that illustrates one embodiment of a method of detecting seismic waves, illustrated as method 400. At step 405, the method 400 includes detecting a first plurality of seismic waves (e.g., 109 in FIG. 3) generated while a first electric submersible pump (ESP) (e.g., 107 in FIG. 3), a first logging tool, or any combination thereof is running at its operating frequency or operating frequencies within a first well (e.g., 105 in FIG. 3). The first plurality of seismic waves (e.g., 109 in FIG. 3) is detected using at least one seismic sensor comprising a seismic sensor within the first well (e.g., 178 in FIG. 3), a seismic sensor within a second well (e.g., 178′ in FIG. 3), a seismic sensor on a surface, or any combination thereof.

At step 410, the method 400 includes recording seismic data for the first plurality of seismic waves (e.g., 109 in FIG. 3) detected by the at least one seismic sensor in an electronic storage (e.g., DAS interrogator 108 and/or electronic storage thereof in FIG. 3). The electronic storage may be practically any electronic storage for storing data, such as, but not limited to, the memory 506 described in the context of FIG. 5. The electronic storage may be a memory, USB, disk, etc.

At step 415, the method 400 includes detecting a second plurality of seismic waves (e.g., 109′ in FIG. 3) generated while a second electric submersible pump (ESP) (e.g., 107′ in FIG. 3), a second logging tool, or any combination thereof is running at its operating frequency or operating frequencies within the second well (e.g., 105′ in FIG. 3). The second plurality of seismic waves (e.g., 109′ in FIG. 3) is detected using the at least one seismic sensor comprising the seismic sensor within the first well (e.g., 178 in FIG. 3), the seismic sensor within the second well (e.g., 178′ in FIG. 3), the seismic sensor on the surface, or any combination thereof.

At step 420, the method 400 includes recording seismic data for the second plurality of seismic waves (e.g., 109′ in FIG. 3) detected by the at least one seismic sensor in the electronic storage (e.g., DAS interrogator 108′ and/or electronic storage thereof in FIG. 3). The electronic storage may be practically any electronic storage for storing data, such as, but not limited to, the memory 506 described in the context of FIG. 5. The electronic storage may be a memory, USB, disk, etc.

At step 425, the method 400 includes detecting a second plurality of seismic waves generated while a second electric submersible pump (ESP), a second logging tool, or any combination thereof is running at its operating frequency or operating frequencies within the first well. For example, FIG. 3 may include a plurality of the ESP 107 in the wellbore 105 and each ESP 107 generates a wavefield such as the wavefield 109. The second plurality of seismic waves is detected using the at least one seismic sensor comprising the seismic sensor within the first well (e.g., 178 in FIG. 3), the seismic sensor within the second well (e.g., 178′ in FIG. 3), the seismic sensor on the surface, or any combination thereof.

At step 430, the method 400 includes recording seismic data for the second plurality of seismic waves detected by the at least one seismic sensor in the electronic storage (e.g., DAS interrogator 108 and/or electronic storage thereof in FIG. 3). The electronic storage may be practically any electronic storage for storing data, such as, but not limited to, the memory 506 described in the context of FIG. 5. The electronic storage may be a memory, USB, disk, etc.

Some embodiments may even include a plurality of seismic sensors such as a plurality of the fiber optic cable 178 in the wellbore 105 in FIG. 3. Some embodiments may even include a plurality of seismic sensors such as a plurality of the fiber optic cable 178′ in the wellbore 105′ in FIG. 3.

Various modification may be made to the method 400. Some embodiments may include 405, 410, 415, 420, 425, and 430 depending on the implementation. Some embodiments may include 405, 410, 415, and 420 depending on the implementation. Some embodiments may include 405, 410, 425, and 430 depending on the implementation. Some embodiments may include 405 and 410 depending on the implementation.

Processing/Imaging: This localized seismic imaging around the wellbore has potential use in wellbore cement quality determination, wellbore integrity evaluation, and potentially static imaging or time lapse imaging (monitoring) of rocks and reservoir.

The seismic dataset recorded by the system of FIG. 1A and FIG. 3 using the ESP 107 and/or ESP 107′ as a seismic source may be processed and imaged by: 1) Near field source signature estimation local to ESP via accelerometer, geophone or fiber optic DAS channel. Data received on single or multiple down hole accelerometers, geophones or fiber optic DAS channels, wave field deconvolved using estimated source signature and wave field imaged. 2) Near field source signature estimation cross-correlated with data received on single or multiple down hole accelerometers, geophones or fiber optic DAS channels, and wave field imaged. 3) Use of interferometry from one or more ESP's and multiple accelerometers, geophones or fiber optic channels for wavefield imaging.

FIG. 5 is a block diagram illustrating a seismic imaging system 500, in accordance with some embodiments. While certain specific features are illustrated, those skilled in the art will appreciate from the present disclosure that various other features have not been illustrated for the sake of brevity and so as not to obscure more pertinent aspects of the embodiments disclosed herein.

To that end, the seismic imaging system 500 includes one or more processing units (CPUs) 502, one or more network interfaces 508 and/or other communications interfaces 503, memory 506, and one or more communication buses 504 for interconnecting these and various other components. The seismic imaging system 500 also includes a user interface 505 (e.g., a display 505-1 and an input device 505-2). The communication buses 504 may include circuitry (sometimes called a chipset) that interconnects and controls communications between system components. Memory 506 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 506 may optionally include one or more storage devices remotely located from the CPUs 502. Memory 506, including the non-volatile and volatile memory devices within memory 506, comprises a non-transitory computer readable storage medium and may store seismic data recorded by the system depicted in FIG. 1A and FIG. 3.

In some embodiments, memory 506 or the non-transitory computer readable storage medium of memory 506 stores the following programs, modules and data structures, or a subset thereof including an operating system 516, a network communication module 518, and a seismic imaging module 520.

The operating system 516 includes procedures for handling various basic system services and for performing hardware dependent tasks.

The network communication module 518 facilitates communication with other devices via the communication network interfaces 508 (wired or wireless) and one or more communication networks, such as the Internet, other wide area networks, local area networks, metropolitan area networks, and so on.

In some embodiments, the seismic imaging module 520 performs seismic data processing and seismic imaging of seismic data recorded using an ESP, logging tool, or any combination thereof as a seismic source. Seismic imaging module 520 may include data sub-module 525, which handles the seismic dataset recorded by the system of FIG. 1A and FIG. 3. This data is supplied by data sub-module 525 to other sub-modules.

Processing sub-module 522 contains a set of instructions 522-1 and accepts metadata and parameters 522-2 that will enable it to perform any seismic data processing required to prepare the data for imaging. The imaging sub-module 523 contains a set of instructions 523-1 and accepts metadata and parameters 523-2 that will enable it to perform seismic imaging, such as migration. Although specific operations have been identified for the sub-modules discussed herein, this is not meant to be limiting. Each sub-module may be configured to execute operations identified as being a part of other sub-modules, and may contain other instructions, metadata, and parameters that allow it to execute other operations of use in processing data and generating images. For example, any of the sub-modules may optionally be able to generate a display that would be sent to and shown on the user interface display 505-1. In addition, any of the data or processed data products may be transmitted via the communication interface(s) 503 or the network interface 508 and may be stored in memory 506.

Method 600 is, optionally, governed by instructions that are stored in computer memory or a non-transitory computer readable storage medium (e.g., memory 506 in FIG. 5) and are executed by one or more processors (e.g., processors 502) of one or more computer systems. The computer readable storage medium may include a magnetic or optical disk storage device, solid state storage devices such as flash memory, or other non-volatile memory device or devices. The computer readable instructions stored on the computer readable storage medium may include one or more of: source code, assembly language code, object code, or another instruction format that is interpreted by one or more processors. In various embodiments, some operations in each method may be combined and/or the order of some operations may be changed from the order shown in the figures. For ease of explanation, method 600 is described as being performed by a computer system, although in some embodiments, various operations of method 600 are distributed across separate computer systems.

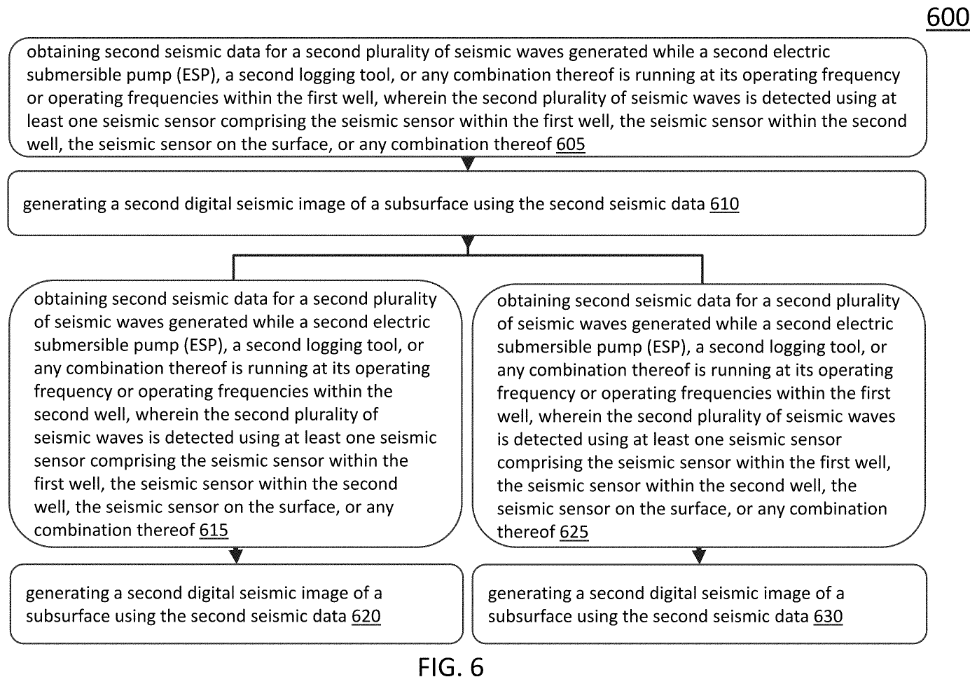

FIG. 6 is a flowchart that illustrates one embodiment of a method of generating a digital seismic image, illustrated as the method 600. At step 605, the method 600 includes obtaining first seismic data for a first plurality of seismic waves (e.g., 109 in FIG. 3) generated while a first electric submersible pump (ESP) (e.g., 107 in FIG. 3), a first logging tool, or any combination thereof is running at its operating frequency or operating frequencies within the first well (e.g., 105 in FIG. 3). The first plurality of seismic waves (e.g., 109 in FIG. 3) is detected using at least one seismic sensor comprising a seismic sensor within the first well (e.g., 178 in FIG. 3), a seismic sensor within a second well (e.g., 178′ in FIG. 3), a seismic sensor on a surface, or any combination thereof.

At step 610, the method 600 includes generating a first digital seismic image of a subsurface using the first seismic data. In some embodiments, generating the first digital seismic image comprises using near field source signature estimation, near field source signature estimation cross-correlation, deconvolution, interferometry, or any combination thereof.

At step 615, the method 600 includes obtaining second seismic data for a second plurality of seismic waves (e.g., 109′ in FIG. 3) generated while a second electric submersible pump (ESP) (e.g., 107′ in FIG. 3), a second logging tool, or any combination thereof is running at its operating frequency or operating frequencies within the second well (e.g., 105′ in FIG. 3). The second plurality of seismic waves (e.g., 109′ in FIG. 3) is detected using at least one seismic sensor comprising the seismic sensor within the first well (e.g., 178 in FIG. 3), the seismic sensor within the second well (e.g., 178′ in FIG. 3), the seismic sensor on the surface, or any combination thereof.

At step 620, the method 600 includes generating a second digital seismic image of a subsurface using the second seismic data. In some embodiments, generating the first digital seismic image comprises using near field source signature estimation, near field source signature estimation cross-correlation, deconvolution, interferometry, or any combination thereof.

At step 625, the method 600 includes obtaining second seismic data for a second plurality of seismic waves generated while a second electric submersible pump (ESP), a second logging tool, or any combination thereof is running at its operating frequency or operating frequencies within the first well. For example, FIG. 3 may include a plurality of the ESP 107 in the wellbore 105 and each ESP 107 generates a wavefield such as the wavefield 109. The second plurality of seismic waves is detected using at least one seismic sensor comprising the seismic sensor within the first well (e.g., 178 in FIG. 3), the seismic sensor within the second well (e.g., 178′ in FIG. 3), the seismic sensor on the surface, or any combination thereof.

At step 630, the method 600 includes generating a second digital seismic image of a subsurface using the second seismic data. In some embodiments, generating the first digital seismic image comprises using near field source signature estimation, near field source signature estimation cross-correlation, deconvolution, interferometry, or any combination thereof.

Various modification may be made to the method 600. Some embodiments may include 605, 610, 615, 620, 625, and 630 depending on the implementation. Some embodiments may include 605, 610, 615, and 620 depending on the implementation. Some embodiments may include 605, 610, 625, and 630 depending on the implementation. Some embodiments may include 605 and 610 depending on the implementation.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. For instance, another embodiment may include detecting a first plurality of seismic waves generated by a non-conventional seismic source within a first well, wherein the first plurality of seismic waves is detected using at least one seismic sensor comprising a seismic sensor within the first well, a seismic sensor within a second well, a seismic sensor on a surface, or any combination thereof; and recording seismic data for the first plurality of seismic waves detected by the at least one seismic sensor in an electronic storage. For instance, another embodiment may include obtaining first seismic data for a first plurality of seismic waves generated by a non-conventional seismic source within the first well, wherein the first plurality of seismic waves is detected using at least one seismic sensor comprising a seismic sensor within the first well, a seismic sensor within a second well, a seismic sensor on a surface, or any combination thereof; and generating a first digital seismic image of a subsurface using the first seismic data. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

The terms “first” and “second” herein are not limiting. Some embodiments may include a first ESP only (i.e., singe ESP). Some embodiments may include both a first ESP and a second ESP (i.e., two ESPs). Some embodiments may include a first ESP and one or more second ESPs, such as more than two ESPs. Some embodiments may include a first logging tool only (i.e., singe logging tool). Some embodiments may include both a first logging tool and a second logging tool (i.e., two logging tools). Some embodiments may include a first logging tool and one or more second logging tools, such as more than two logging tools. Thus, the term “second” may be one or more even if not explicitly stated.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

Unless defined otherwise, all technical and scientific terms used herein have the same meanings as commonly understood by one of skill in the art to which the disclosed invention belongs. All citations referred herein are expressly incorporated by reference.

What is claimed is:

1. A method of detecting seismic waves, the method comprising:
detecting a first plurality of seismic waves generated while a first electric submersible pump (ESP), a first logging tool, or any combination thereof is running at its operating frequency or operating frequencies within a first well, wherein the first plurality of seismic waves is detected using at least one seismic sensor comprising a seismic sensor within the first well, a seismic sensor within a second well, a seismic sensor on a surface, or any combination thereof; and
recording seismic data for the first plurality of seismic waves detected by the at least one seismic sensor in an electronic storage.

2. The method of claim 1, wherein the first plurality of seismic waves is generated by electrical hum, bearing rumble, cavitation, fluid and gas flow, or any combination thereof.

3. The method of claim 1, wherein the at least one seismic sensor comprises fiber optic distributed sensing.

4. The method of claim 3, wherein the at least one seismic sensor comprises one or more fiber optic cables configured for distributed acoustic sensing (DAS).

5. The method of claim 1, wherein the at least one seismic sensor comprises one or more geophones, one or more accelerometers, one or more point sensors, or any combination thereof.

6. The method of claim 1, further comprising:
detecting a second plurality of seismic waves generated while a second electric submersible pump (ESP), a second logging tool, or any combination thereof is running at its operating frequency or operating frequencies within the first well, wherein the second plurality of seismic waves is detected using the at least one seismic sensor comprising the seismic sensor within the first well, the seismic sensor within the second well, the seismic sensor on the surface, or any combination thereof; and
recording seismic data for the second plurality of seismic waves detected by the at least one seismic sensor in the electronic storage.

7. The method of claim 1, further comprising:
detecting a second plurality of seismic waves generated while a second electric submersible pump (ESP), a second logging tool, or any combination thereof is running at its operating frequency or operating frequencies within the second well, wherein the second plurality of seismic waves is detected using the at least one seismic sensor comprising the seismic sensor within the first well, the seismic sensor within the second well, the seismic sensor on the surface, or any combination thereof; and
recording seismic data for the second plurality of seismic waves detected by the at least one seismic sensor in the electronic storage.

8. A system of detecting seismic waves, the system comprising:
a first electric submersible pump (ESP), a first logging tool, or any combination thereof within a first well;
at least one seismic sensor comprising a seismic sensor within the first well, a seismic sensor within a second well, a seismic sensor on a surface, or any combination thereof to detect a first plurality of seismic waves generated while the first electric submersible pump (ESP), the first logging tool, or any combination thereof is running at its operating frequency or operating frequencies within the first well; and
an electronic storage to record seismic data for the first plurality of seismic waves detected by the at least one seismic sensor.

9. The system of claim 8, wherein the first plurality of seismic waves is generated by electrical hum, bearing rumble, cavitation, fluid and gas flow, or any combination thereof.

10. The system of claim 8, wherein the at least one seismic sensor comprises fiber optic distributed sensing.

11. The system of claim 10, wherein the at least one seismic sensor comprises one or more fiber optic cables configured for distributed acoustic sensing (DAS).

12. The system of claim 8, wherein the at least one seismic sensor comprises one or more geophones, one or more accelerometers, one or more point sensors, or any combination thereof.

13. The system of claim 8, further comprising:
a second electric submersible pump (ESP), a second logging tool, or any combination thereof within the first well; and
the at least one seismic sensor comprising the seismic sensor within the first well, the seismic sensor within the second well, the seismic sensor on the surface, or any combination thereof to detect a second plurality of seismic waves generated while the second electric submersible pump (ESP), the second logging tool, or any combination thereof is running at its operating frequency or operating frequencies within the first well; and
wherein the electronic storage to record seismic data for the second plurality of seismic waves detected by the at least one seismic sensor.

14. The system of claim 8, further comprising:
a second electric submersible pump (ESP), a second logging tool, or any combination thereof within the second well; and
the at least one seismic sensor comprising the seismic sensor within the first well, the seismic sensor within the second well, the seismic sensor on the surface, or any combination thereof to detect a second plurality of seismic waves generated while the second electric submersible pump (ESP), the second logging tool, or any combination thereof is running at its operating frequency or operating frequencies within the second well; and
wherein the electronic storage to record seismic data for the second plurality of seismic waves detected by the at least one seismic sensor.

15. A method of generating a digital seismic image, the method comprising:
obtaining first seismic data for a first plurality of seismic waves generated while a first electric submersible pump (ESP), a first logging tool, or any combination thereof is running at its operating frequency or operating frequencies within the first well, wherein the first plurality of seismic waves is detected using at least one seismic sensor comprising a seismic sensor within the first well, a seismic sensor within a second well, a seismic sensor on a surface, or any combination thereof; and
generating a first digital seismic image of a subsurface using the first seismic data.

16. The method of claim 15, wherein generating the first digital seismic image comprises using near field source signature estimation, near field source signature estimation cross-correlation, deconvolution, interferometry, or any combination thereof.

17. The method of claim 15, wherein the first plurality of seismic waves is generated by electrical hum, bearing rumble, cavitation, fluid and gas flow, or any combination thereof.

18. The method of claim 15, wherein the at least one seismic sensor comprises fiber optic distributed sensing.

19. The method of claim 18, wherein the at least one seismic sensor comprises one or more fiber optic cables configured for distributed acoustic sensing (DAS).

20. The method of claim 15, wherein the at least one seismic sensor comprises one or more geophones, one or more accelerometers, one or more point sensors, or any combination thereof.

21. The method of claim 15, further comprising:
obtaining second seismic data for a second plurality of seismic waves generated while a second electric submersible pump (ESP), a second logging tool, or any combination thereof is running at its operating frequency or operating frequencies within the first well, wherein the second plurality of seismic waves is detected using at least one seismic sensor comprising the seismic sensor within the first well, the seismic sensor within the second well, the seismic sensor on the surface, or any combination thereof; and
generating a second digital seismic image of a subsurface using the second seismic data.

22. The method of claim 15, further comprising:
obtaining second seismic data for a second plurality of seismic waves generated while a second electric submersible pump (ESP), a second logging tool, or any combination thereof is running at its operating frequency or operating frequencies within the second well, wherein the second plurality of seismic waves is detected using at least one seismic sensor comprising the seismic sensor within the first well, the seismic sensor within the second well, the seismic sensor on the surface, or any combination thereof; and
generating a second digital seismic image of a subsurface using the second seismic data.

23. A computer system a generating a digital seismic image, the system comprising:
one or more processors, memory, and one or more programs, wherein the one or more programs are stored in the memory and configured to be executed by the one or more processors, wherein the one or more programs include an operating system and instructions that when executed by the one or more processors cause the computer system to:
obtain first seismic data for a first plurality of seismic waves generated while a first electric submersible pump (ESP), a first logging tool, or any combination thereof is running at its operating frequency or operating frequencies within the first well, wherein the first plurality of seismic waves is detected using at least one seismic sensor comprising a seismic sensor within the first well, a seismic sensor within a second well, a seismic sensor on a surface, or any combination thereof; and
generate a first digital seismic image of a subsurface using the first seismic data.

24. The system of claim 23, wherein the at least one seismic sensor comprises one or more fiber optic cables configured for distributed acoustic sensing (DAS).

25. The system of claim 23, wherein the instructions when executed by the one or more processors cause the computer system to:
obtain second seismic data for a second plurality of seismic waves generated while a second electric submersible pump (ESP), a second logging tool, or any combination thereof is running at its operating frequency or operating frequencies within the first well, wherein the second plurality of seismic waves is detected using at least one seismic sensor comprising the seismic sensor within the first well, the seismic sensor within the second well, the seismic sensor on the surface, or any combination thereof; and
generate a second digital seismic image of a subsurface using the second seismic data.

26. The system of claim 23, wherein the instructions when executed by the one or more processors cause the computer system to:
obtain second seismic data for a second plurality of seismic waves generated while a second electric submersible pump (ESP), a second logging tool, or any combination thereof is running at its operating frequency or operating frequencies within the second well, wherein the second plurality of seismic waves is detected using at least one seismic sensor comprising the seismic sensor within the first well, the seismic sensor within the second well, the seismic sensor on the surface, or any combination thereof; and
generate a second digital seismic image of a subsurface using the second seismic data.
